(19) United States
(12) Patent Application Publication
(10) Pub. No.: US 2017/0212967 A1
(43) Pub. Date: Jul. 27, 2017

(54) COMPASS TOOL FOR COMPUTER-AIDED DESIGN OF BENDS OR CONNECTIONS OF PIPING OR CONDUIT

(71) Applicant: TRIMBLE NAVIGATION LIMITED, SUNNYVALE, CA (US)

(72) Inventors: MICHAEL LAYNG DEXTER, CASTLE PINES, CO (US); DOUGLAS MICHAEL ELLIOTT, AURORA, CO (US)

(21) Appl. No.: 15/007,485

(22) Filed: Jan. 27, 2016

(51) Int. Cl. G06F 17/50; G06F 3/0484; G06F 3/0482

(52) U.S. Cl. CPC G06F 17/5004; G06F 3/0482; G06F 3/04845; G06F 2217/34

(57) ABSTRACT

A compass tool for use with a digital modeling (e.g., a computer-aided design (CAD)) program to model and visualize rotation of a conduit bend or other connector. The compass tool generates a graphical representation of a compass or compass element. The compass element has a planar, circular-shaped body that is arranged orthogonal to the end of conduit to be sandwiched between the conduit end and the first end of the connector. The compass element's body is formed with one to four or more bands that are each defined by concentric rings having increasing diameters and centers coinciding with the center of the compass body. Compass measurement marks are provided with differing divisions in each band, e.g., 90 degree increments marked in the first (innermost band), 45 degree increments marked in the second band, 15 degree increments marked in the third band, and 5 degree increments marked in the fourth band.

### BACKGROUND

1. Field of the Invention

The present invention generally relates to computer-aided design (CAD) programs, construction-related and three-dimensional (3D) modeling software, and applications such as estimating (with on screen takeoff and the like) (all of which are considered CAD programs or software suites in this description) and, more particularly, to methods of facilitating the design of a piping or conduit system, such as for a building, by providing tools for better visualizing the joining of two conduit or pipe segments or runs with a bend or connector (e.g., an elbow in a piping system) having a particular angular orientation. Note, the term “conduit” is considered to be a broad term in the following description that includes any circular or square object (e.g., a tube as well as a round or square solid face), pipe, tubing, and nearly any other elongated structure used in building and other structural designs (e.g., to carry water, air, and other fluids (such as part of a heating, ventilation, and air conditioning (HVAC) system), to run power, control, and communication wiring, and so on). The terms “bend” and “connector” for two conduit segments or runs may be used interchangeably herein (e.g., the “connector” may be a section of conduit with a bend and may be integrally formed with or be part of the two conduit sections being “connected”).

2. Relevant Background

Computer-aided design (CAD) has been in wide use for many years and generally involves the use of computer systems to aid in the creation, modification, analysis, and optimization of a design. CAD software or programs are widely used in the architectural and construction industries for designing new buildings or new systems for existing buildings. CAD programs allow a designer to efficiently build two-dimensional (2D) and three-dimensional (3D) models of a building and its systems including its plumbing, electrical, communications, and HVAC systems.

Each of these systems will include numerous runs of conduit (or piping) that must be planned out to fit within run spaces in the building, and this may be a very complex task especially when the conduit must pass through walls and ceilings and/or follow a very circuitous path with numerous turns or bends. Typically, the runs of conduit will need to include numerous connectors or bends (or bent portions such as bendable conduit) to follow this path. These conduit systems can be modeled and visualized in graphical user interfaces (GUIs) generated by the CAD program. However, the GUI may not provide the user with enough detail about the connector or bend used to join two conduit section, which can further complicate the design process due to the difficulty of visualizing the conduit design.

As a specific example, CAD programs are commercially available that include 2D or 3D modeling tools specially adapted for use by the mechanical, electrical, and plumbing contractor. These modeling tools are configured to allow the contractor to create custom components and route conduit through a 2D or 3D model such as a model of a building or structure. Some of these tools allow the user to draw conduit with bends (or other conduit segment connectors such as elbows) so as to try to model the conduit as it may be actually installed in the field. However, as discussed above, it is often difficult to visualize the amount of bend needed or actually implemented in the model where two runs of conduit are joined.

Hence, there remains a need for tools or software modules/programs for CAD programs that enhances the user interface or GUI to improve the process of modeling conduit systems. Preferably, such new tools/software modules would allow the user of the CAD program readily visualize and then easily select and/or change the angular orientation of the connector (which may be a bend or bent portion of the conduit) that is used to joint two segments or runs of conduit so as to improve the modeling of mechanical, electrical, and plumbing systems.

### SUMMARY

Briefly, a compass tool (or subroutine) is described for use with a CAD program to better model and visualize rotation of a conduit bend or other connector (such as an elbow for piping, tubing, round or square object (e.g., a tube or round/square solid such as structural supports (e.g., steel supports), or other “conduit”). The compass tool may be provided as part of a bend installation subroutine or portion of the CAD program. The compass tool is useful for generating and displaying a graphical representation of a compass or compass face (called a “compass element” or “compass object” herein). The compass element has a planar, circular-shaped body that is arranged orthogonal to the end of conduit to which the bend/connector is to be provided (e.g., sandwiched between the conduit end and the first end of the bend/connector).

The compass element's body is typically formed of one, two, three, four, or more bands that are each defined by concentric rings having increasing diameters and centers coinciding with the center axis of the compass element's body (and center axis of the conduit). Compass measurement marks or ticks (or tick marks) are provided with differing divisions in each band, e.g., 90 degree increments marked in the first (innermost band), 45 degree increments marked in the second band, 15 degree increments marked in the third band, 5 degree increments marked in the fourth band, and so on. Each of these bands (or concentric rings) of the compass element are greater in diameter than the outer diameter of the conduit so as to be readily visible to a user of the CAD GUI. In some cases, only a subset of these bands will be shown/displayed in the CAD GUI to suit a particular application.

The compass tool acts to measure/determine the current rotation angle of the connector in response to user input causing the connector to be rotated about the center axis of the conduit (or conduit end to which the connector is attached). The compass tool also provides visual indication of the current rotation angle in a variety of ways. First, a bar-shaped rotation angle indicator (or rotation angle needle) may be displayed within the body of the compass element and extend outward from the center of the body to a point outside the outermost band. Numerical references of angular rotation amounts may be provided in a circular pattern outside the outermost band (e.g., at 45 degree increments from 0 to 315 degrees) such that the proximity of the angle indicator or needle shows the GUI user the rotation angle. Second, tool tip may be displayed that corresponds to location in the GUI of a user input device (e.g., a mouse, a touchpad, or the like), and this may be an arrow or other graphical object that may be “snapped” to each increment or tick mark in the bands (when the tool tip is in the body of the compass element) and be moved freely (or with free-form) outside the compass element body. Third, the compass tool may include (in a display box/window or the like) the numerical representation of the measurement, and the numerical representation (e.g., “60” or “60 degrees” or the like) may be provided adjacent and proximate to the tool tip in the GUI.

More particularly, a method of providing a user interface for digital modeling is provided. The method includes, with a processor of a computer system, running a computer-aided design (CAD) program (or executing executable code or computer instructions) to generate and display a graphical user interface (GUI) on a display device or monitor of the computer system. Then, with the CAD program, the method includes detecting, via operation of a user input device, user selection of a conduit end, displayed in the GUI, to connect with a connector to a next conduit run. The method also includes displaying the connector attached to the conduit end and rotated to an initial rotation angle relative to the central axis of the conduit end. Then, the method involves displaying a compass element, with a circular-shaped planar body oriented to be orthogonal to the conduit end, over the conduit end. The body of the compass element has an outer diameter greater than an outer diameter of the conduit end and a first band, including a plurality of compass measurement marks, extending outward from the conduit end.

In some implementations, the method further involves, concurrent with the displaying of the compass element, determining a current rotation angle of the connector and displaying a visual indication of the current rotation angle in the GUI. Then, the visual indication may include an elongated rotation angle indicator extending from a center of the body of the compass element to a point outside the body of the compass element. In the same implementation or another, the visual indication comprises a display box including a numeric representation of the current rotation angle. In such cases, the method may also involve displaying a tool tip in the GUI corresponding to movement of the user input device causing rotation of the connector relative to the central axis of the conduit end, and the display box can be displayed in a position adjacent and proximate to the tool tip in the GUI. The tool tip can be controlled to be snapped onto a nearest one of the compass measurement marks when the tool tip is positioned within the body of the compass element. Further, the tool tip can be controlled so as to be positionable in the GUI to provide free-form rotation of the connector when the tool tip is positioned outside the body of the compass element, and the display box can be displayed to provide the current rotation angle of the connector with the tool tip positioned in a 3D model of a structure displayed in the GUI.

In some implementations of the method, the body of the compass element includes a second band including a plurality of compass measurement marks, and the first and second band are defined by concentric rings of differing diameter. The compass measurement marks of the first band, which is more inner than the second band, can then be spaced apart a greater distance than those of the second band indicative of a larger incremental measurement of a rotation angle of the connector. In some cases, the compass measurement marks of the first band are provided at 90 degree increments and the compass measurement marks of the second band are provided at 45 degree increments. In these cases, third and fourth bands in the body of the compass element may be provided that are defined by additional concentric rings having greater diameters than the diameters of the concentric rings defining the first and second bands, and the compass measurement marks of the third band are provided at 15 degree increments and the compass measurement marks of the fourth band are provided at 5 degree increments. In these or other implementations of the method, the connector is defined as being at a 90 degree rotation angle when rotated to extend vertically upward in the GUI.

### BRIEF DESCRIPTION OF THE DRAWINGS

FIG. 1 is a functional block diagram or schematic a computer system running software or executable code for a CAD program with a compass tool of the present description;

FIG. 2 illustrates an screen shot of the user interface or compass element/object generated by a compass tool described herein for use with a CAD program as it is being used to rotate and set a rotation angle for a conduit bend or connector;

FIG. 3 illustrates an additional screen shot of a CAD GUI with an end or normal view of a user interface or compass element/object generated by the compass tool in further detail;

FIG. 4 illustrates another screen shot of a CAD GUI similar to FIG. 2 but showing an alternative compass configuration with a single band with tick marks visually indicative to compass measurements (or amounts of angular rotation of a connector); and

FIG. 5 is a flow diagram of a method of generating and displaying a compass element or object (or “compass”) in a CAD GUI by operation of compass tool.

### DETAILED DESCRIPTION

The following describes a compass tool for use with a CAD program for providing enhanced visualization of bends or other connectors (such as elbows) used to turn or redirect conduit (which may include pipe, tubing, and the like) in a 2D or 3D model of a structure such as a digital model of a building created by the CAD program. Briefly, the compass tool functions to generate a graphical compass object or element that is displayed, within a GUI for the CAD program, at the end of a segment of conduit that is to be turned or redirected with a bend, elbow, or other connector. The compass element may be thought of as having a planar, circular-shaped body with an outer diameter greater than the outer diameter of the conduit such that one, two, three, four, or more bands extends outward about the periphery of the end of the conduit. The compass element is oriented to be orthogonal to the axis of the conduit, and each of these bands or rings display angular measurements or markings (or compass points or ticks) that can be used to show the present angular rotation or orientation of the bend or other connector placed on the end of the conduit and rotated about the axis of the conduit by the user/operator of the CAD program (or the computer running the CAD program).

As will become clear from the following description, the compass tool and its generated compass element (or compass tool interface) provides a number of advantages and useful functions when compared with prior bend-assist tools. Prior bend-assist tools typically were limited to providing a simple compass image on the end of the conduit, but it was sized to match the outer diameter of the conduit and did not provide easy identification of the present angular rotation of a bend or connector. In contrast, the compass tool creates the compass object/element so as to have compass ticks or measurements (e.g., degree markings) in bands or rings outside of the conduit for easier viewing. Each successive ring or band is designed to provide a greater amount of granularity such as with 90 degree ticks or divisions in the innermost ring, 45 degree divisions in the second ring, 15 degree divisions in the third ring, 5 degree divisions in the fourth ring, and so on. In most implementations, the compass body retains a fixed outer diameter regardless of the amount of zooming in and out from the conduit (or end of conduit) so that the user/operator is able to more readily use the compass tool to select a rotation angle or angular orientation of a bend/connector (e.g., compass element does not shrink when zoom out which would often make it difficult or impossible to read the compass readouts or measurements of the present rotation angle).

The compass tool may be designed to a rotation angle measurement bar that follows the user's rotation of the bend/connector to provide an indication of the present rotation angle or angular orientation on the face of the compass element/object in the CAD GUI. The compass tool may allow free rotation of the bend/connector when a tool tip (mouse pointer or arrowhead or the like) is placed outside the outermost band/ring of the compass element. A compass readout (e.g., in a box near the tool tip) may be used to display a presently calculated/determined angular orientation or rotation angle whether the tool tip is within the compass rings/bands or outside these rings/bands so as to provide accurate measurement of the present rotation of the bend/connector, e.g., the user can infer any angle they want from building entities by placing the tool tip or pointing to any nearby structural element (such as to determine amount of turn or bend needed by the connector to have next run of conduit travel toward a feature in the CAD-modeled building). The compass tool may be configured or designed so that when the tool tip is moved within the bands/rings of the graphical compass element in the CAD GUI that the rotation/movement of the bend/connector occurs with snaps or jumps to nearest ticks/divisions in the present band/ring. These may be thought of as “intelligent snaps” to assist the user/operator in selecting practical rotation angles for the bend/connector, and the compass readout may provide the present snap angle (present compass degrees) near the present location of the tool tip.

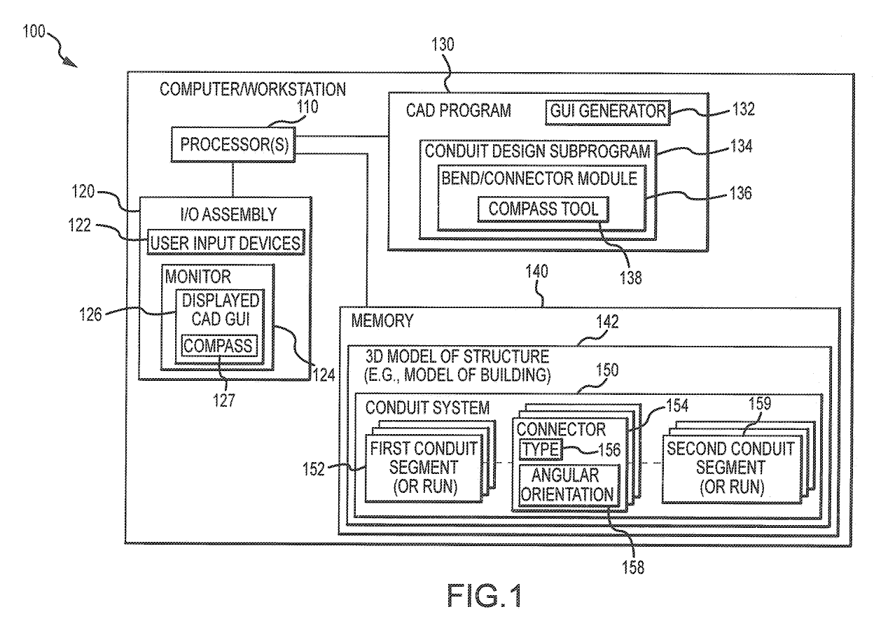

Prior to turning to specific screen shots or implementations of the compass design tool, it may be useful to describe more generally a CAD-based implementation. FIG. 1 illustrates a computer or workstation 100 that may be used by an operator or user (not shown) to interact with or use computer-aided design (CAD) software to design a structure, such as a building, with electrical, plumbing, HVAC, and/or other systems of conduit or piping that needs to be properly placed and run throughout the designed or modeled structure. The computer 100 may take a wide variety of forms such as a desktop computer system, a notebook computer, a laptop computer, a touchpad, a smartphone, or the like, with the particular form of the computer 100 not being limiting to the invention. The computer 100 includes one or more processors 110 that manage memory (e.g., computer-readable media) 140 and execute code or run software to provide the user or operator a CAD program 130 (e.g., SketchUp™ from Trimble Navigation Limited or other commercially-available 3D CAD design software package).

The processor 110 also controls or manages operations of an input/output (I/O) assembly 120 for the computer 100. The assembly 120 includes user input devices 122 allowing an operator or user of the computer 100 to initiate running of the CAD program 130 by the processor 110 and allows the user to interact with the CAD program 130 such as to provide user input to create a 3D model of a structure 142 that may be stored in memory 140. The I/O devices 122 may include a keyboard, a mouse, one or more touchscreens/pads with input pens or other devices, voice recognition software, and so on. The I/O assembly 120 also includes a monitor or display device 124 that, during the running of the CAD program 130, is used to display to the user/operator of the computer 100 a CAD GUI or user interface 126 that is generated by the GUI generator 132 of the CAD program 130 (or a separate program).

Screen shots of exemplary GUIs 126 that may be provided by GUI generator 132 are provided in other figures and described in detail below as part of the discussion of the compass design tool and compass methods. The user input devices 122 may be operated while the CAD GUI 126 is displayed on the monitor 124 to provide user input to activate/initiate and then use the compass tool 138 to design, position, and orient bends/connectors 154 between segments or runs of conduit 152, 159.

As shown, the CAD program 130 may be utilized by an operator of the computer 100 to create and/or modify a 3D model of a structure 142 (e.g., a digital model of a building). The CAD program 130 is shown to include a conduit design subprogram or routine 134 that the user of the computer 100 may activate or run (such as via a selection of a tab or icon in the CAD GUI 126 via user input devices 122) for use in generating a conduit system 150 in the 3D model 142. Further, a bend/connector module 136 may be initiated or activated as part of the conduit design subprogram 134 to assist the user/operator in creating the conduit system 150 such as by connecting first conduit runs or segments 152 to second conduit segments or runs 159 via connectors 154 of particular types 156 (e.g., the user may choose to connect the segments 152, 159 with a bend in the conduit with a particular radius, with an elbow, or with other mechanical coupling devices).

Significantly, a compass tool 138 is provided that may be selected by the user via the CAD GUI 126 to assist the user in selecting, positioning, and orienting the connector 154 between the two conduit segments 152, 159. Particularly, as shown, the compass tool 138 is useful for allowing the user to model a number of differing angular orientations and then to select a desirable angular orientation 158 for the conduit bend or other connector 154. As explained below, the compass tool 138 is useful by itself or with the GUI generator 132 to update or modify the CAD GUI 126 to graphical compass image or element 127 at the “joint” between the first conduit segment 152 and the connector/conduit bend 154. In practice, there may not be a physical joint in practice when the conduit is simply bent in the field but the compass tool 138 may at least initially show a seam or joint between an end of the first segment 152 and a mating end of the connector 154.

The compass element 127 is generated by the compass tool 138 so as to effectively display the present angular orientation 158 of the connector 154 relative to the first conduit segment or run 152 so as to allow the user/operator to quickly and accurately visualize in the CAD GUI 126 on monitor 124 the angular orientation and how the connector 154 should be oriented to properly position the connector 154 in the structure 142 and also to direct the second conduit segment or run 159, which is extended or run from the second end of the bend or connector 154 upon setting or selection of the angular orientation 158 by the user via user input devices 122 (e.g., by a mouse click or a snapping in the compass element 127).

The compass element 127 may be created graphically to have a planar and circular-shaped body provided at the end of the first conduit segment 152 so as to be orthogonal to this conduit end (i.e., orthogonal to axis of the conduit). The body of the compass element 127 may be greater in diameter than the conduit segment 152 so as to extend outward from the outer perimeter of the conduit segment 152 (e.g., in one, two, three, or more rings or bands each designed to provide further detail or measurement of the angular orientation of the connector/bend 154) to facilitate easier visualization of the present angular orientation or angular offset 158 of the connector/bend 154 (as explained below in more detail). In many cases, it may be difficult to fabricate the conduit bends or other connectors 154 such as elbows in the field, and the connector definitions 154 may be exported or otherwise used to manufacture the conduit bends or other connectors 154 for later use in assembling a conduit system meeting the definitions/specifications of the modeled conduit system 150.

The “angular orientation” or angular offset of the bend or connector 154 may be measured as the magnitude of angular rotation from horizontal (which may provide an orientation 158 of 0 degrees) of a plane passing centrally through or bisecting the connector/bend 154. Stated differently, the compass tool 138 allows the user/operator via the user input devices 122 and CAD GUI 126 to place or set the conduit bend/connector 154 and then rotate it to defined the direction of the next segment or straight 159 by selecting (e.g., clicking on the compass element 127) a particular offset angle, rotation angle, or angular orientation 158.

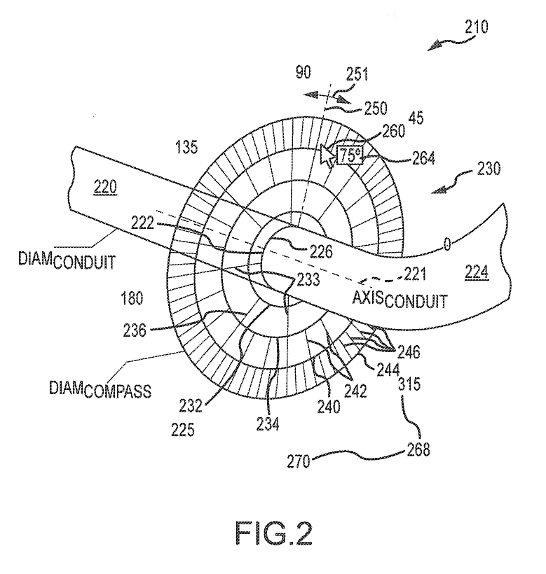

FIG. 2 illustrates a screen shot 210 of a CAD GUI (such as GUI 126 provided during operations of computer 100 in FIG. 1) during operation of a CAD program with a compass tool of the present description. Particularly, the compass tool (by itself or with a GUI generator) is operating in a first state to generate and display a compass element 230 that has a planar, circular-shaped body. In the screen shot 210, the GUI can be seen to include a first conduit run or segment 220 with an end 222, and the compass object or element 230 is provided at this end 222 so as to be orthogonal to the central axis 221 of the conduit 220 and also with its center coinciding with the conduit's central axis 221. The body of the compass element/object 230 is generally transparent so that the conduit 220 and its end 222 that mates with an end of a conduit bend or connector 224 remain visible to the viewer in the GUI.

The compass element 230 is made up of a series of concentric rings or bands 232, 234, 240, 244 associated with compass ticks or marks, and the granularity of the compass readings/measurements increases with band or ring 232, 234, 240, 244. As shown, the inner band 232 has ticks or marks 233 showing 90 degree compass points or angular measurements (in degrees in this non-limiting example) about center axis 221 of the first conduit segment 222, with 0 degrees being at horizontal and to the viewer's right (or to the left of the conduit 220 facing outward from the end 222) and 90 degrees being “up” in the GUI.

Further, as shown, the next or second band 234 includes ticks or marks showing 45 degree compass points or angular measurement divisions. These relatively coarse angular measurements or compass measurements are indicated with numerals 268 about the outer periphery of the compass element/object to assist the user of the GUI and compass tool to determine the angular orientation or rotation angle of the conduit bend or connector 224. In other embodiments, the compass measurements associated with the ticks or marks of a different ring or band may be reflected in the peripheral numerals 268. In this example, the compass element 230 also includes a third ring/band 240 that has ticks or marks 242 associated with or corresponding with compass measurements of 15 degrees. A fourth or outermost ring/band 244 is provided adjacent the third ring/band 240 that provides the highest level of granularity in the compass element with ticks or marks 246 corresponding with compass measurements or divisions of 5 degrees. The fourth bank 244 defines an outer diameter, Diam_{Compass}, of the compass element 230, which is preferably chosen to be greater than outer diameter, Diam_{Conduit}, of the conduit 220 to make the ticks/marks of each band/ring more readily apparent to the viewer of the GUI as shown in screen shot 210. In some embodiments, the compass element 230 is updated with zooms in or out or changes in the view such as to retain the same relative size to the conduit 220 (e.g., scales to view so as to always remain larger in outer diameter than the conduit 220).

In the GUI, the compass tool may further generate a current (or present) rotation angle indicator 250 in the body of the compass element 230. The indicator 250 may take the form of a bar extending outward from the center axis 221 of the conduit 222 in the plane of the compass element 230, and this bar-shaped indicator 250 may move with the rotation of the conduit bend/connector 224 as shown with arrow 251. The bar-shaped indicator 250 may be colored so as to contrast with or differ from the color of the body of the compass element 230 to increase its visibility in the GUI, and the indicator 250 may also have a length that is greater than the radius of the outer ring 244 such that it extends outward a distance from the compass element 230 to even further increase its visibility to a user of the compass tool (e.g., to have a length matching or even exceeding the radius at which the degree-indicating numerals 268 are provided).

To position the bend or connector 224 (e.g., an 90-degree elbow or the like), the compass tool may provide a rotation tool tip 260 that the user/operator of the computer running the CAD program with the compass tool can use to rotate 251 the bend/connector 224. In other words, the user provides input by selecting the tool tip 260 (e.g., with a touchscreen or mouse) and moving either within the body and bands/rings 232, 234, 240, 244 of the compass element 230 or outside the compass element 230. A compass measurement display 264 may be provided near the tool tip 260 providing a current compass measurement of the rotation angle or angular orientation of the conduit bend or connector 224 relative to the center axis 221 of the conduit 220. Outside the compass element 230, the tool tip 260 is provided with free movement or free rotation 251 of the indicator 250 and, concurrently, of the bend or connector 224, and the user can determine or infer the rotation angle from any point or location within the model shown in the GUI simply by moving the tool tip 260 to point at that point/structure. Inside the compass element 230, the movement of the tool tip 260 is controlled by the compass tool to be to snap points within each band 232, 234, 240, 244, and these snap points may coincide with the ticks or marks 233, 236, 242, 246 (e.g., the tool tip 260 may be jumped or snapped to a nearest one of these compass measurement or division marks).

As will be understood from the discussion of the GUI screen shot 210, the compass tool is useful for addressing the desire of CAD program users to view the corresponding rotation angle at a tool tip. Particularly, the box 264 is used to display the present rotation angle of the conduit bend or connector 224 whenever the tool tip 260 is paused (when positioned outside the compass bands/body and the user input device (e.g., a mouse) is held in a particular position in the GUI for more than a predefined period of time (e.g., more than 0.5 to 1 second)) or snapping to a compass tick mark (when positioned inside the compass bands/body). The tool tip angle may not be shown in some embodiments during rotation (e.g., the display box 264 may be hidden until a pause is identified or the tool tip 260 is snapped to a tick mark (e.g., during monitoring for mouse or other user input device events).

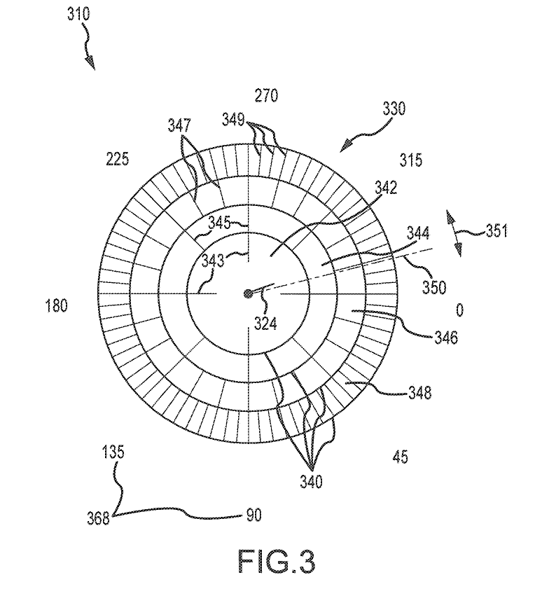

FIG. 3 illustrates another GUI screen shot 310 of a GUI that may be generated by a CAD program with a compass tool of the present description. In this example, an elbow or connector 324 is shown (smaller than typically represented in practice) and with a central axis of a first portion of the connector 324 (the portion that would mate with the first run or segment of conduit (not shown in FIG. 3) passing through a center axis of a compass object/element 330. The compass object/element 330 is shown with an end view, and a rotation angle indicator (e.g., an elongated bar) 350 is shown that is parallel to a center axis of a second portion of the connector 324 (e.g., the portion connected to a second run or straight of conduit (not shown) once the connector 324 is rotated to a desired rotation angle). The rotation angle indicator 350 rotates 351 with the rotation of the connector 324 in response to user input via a user input device.

The compass object or element 330 includes a plurality of concentric rings/circles 340 defining outer diameters of concentric bands 342, 344, 346, 348 of the compass element 330. Within each band 342, 344, 346, 348, more and more granular compass measurements are visually indicated with tick marks 343, 345, 347, 349, respectively. In the band 342, the tick marks 343 are provided at 90 degree intervals. In the band 344, the tick marks 345 are provided at 45 degree intervals. In the band 346, the tick marks 347 are provided at 15 degree intervals, and, in the band 348, the tick marks 349 are provided at 5 degree intervals. The compass tool may also function to display compass measurement reference numerals 368 in a circular pattern with a diameter greater than the outer diameter of the outer most band 348 so as to be ready visible to a user of the compass tool of the CAD program.

As will be understood from the discussion of the GUI screen shot 310, the compass tool is useful for addressing the desire of CAD program users to be able to utilize the tick marks on the compass 330 to facilitate the rotation of a modeled connector 324 (e.g., make its rotation and accurate positioning easier in the CAD GUI). To this end, the compass tool was configured to generate the additional circles or outer diameter boundaries 340 to better delineate the sections or bands 342, 344, 346, 348. The compass tool is also adapted to allow free-form rotation of the connector 324 when the user's tool tip is outside the compass 330 but to provide inside the compass 330 to snap to the nearest tick marks 343, 345, 347, 349 of the band 342, 344, 346, 348 in which the tool tip is positioned (e.g., with 90 degree increments, with 45 degree increments, with 15 degree increments, and with 5 degree increments in this example). In the screen shot 310, “up” was at 270 degrees, but, as discussed with reference to FIG. 2, it may be preferable in many cases for 90 degrees to be “up” in all cases and for 0 degrees to be toward the right (when viewing the end of the first run or segment of conduit to which a connector is being affixed and rotated to a desired rotation angle).

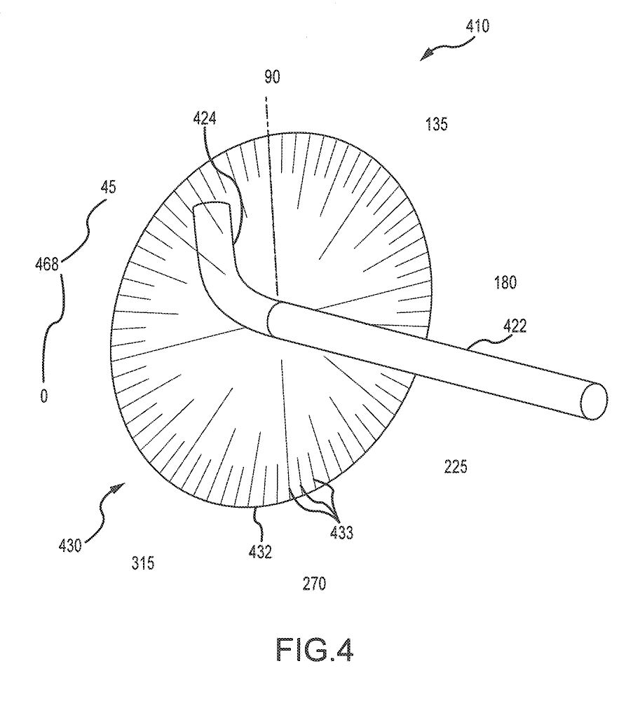

Other embodiments of the compass element or graphical compass may be generated and displayed with a compass tool of the present description. For example, fewer or more bands may be provided in the compass element such as a 45 degree band and a 5 degree band in a two-band implementation. FIG. 4 illustrates a screen shot 410 of a CAD GUI with a graphical compass 430 generated and displayed by another compass tool of the present description. In the GUI of screen shot, the compass tool is providing the compass 430 to assist a user in modeling a bend or connector 424 for joining the segment or run of conduit 422 with a straight or other run/segment (not shown but understood from FIG. 2).

The compass 430 is shown from the conduit segment side, and the compass measurement reference numbers 468 about the periphery of the compass 430 indicate 90 degrees is “up” while 0 degrees of rotation is to the left (at horizontal). In this embodiment of the compass tool, the location of the bend/connector 424 is used to provide a guide or indicator of the amount of rotation with no bar-shaped indicator provided (but, in other cases, the indicator (such as indicator 250 of FIG. 2) is included to assist the user of the compass tool). Also, while not shown, the rotation angle measurement display box (such as box 264) may be provided by a tool tip (not shown in FIG. 4 but understood from FIG. 2).

Another difference in the compass 430 is that only a single band is defined by external circular boundary or ring 432, and tick marks 433 are provided at 5 degree increments about the outer edge of this boundary 432. The tick marks 433 are provided at differing lengths to indicate values in a visual manner, such as with 90 degree marks 433 extending from boundary 432 to the center of the compass 430, with 45 degree marks extending about ⅔ of the distance, with 15 degree marks extending about ⅓ of the distance, and 5 degree marks extending about ⅕ of the distance. As with embodiments, snapping to marks 433 may be provided with a tool tip in the compass 430 and free rotation outside the outer boundary 432.

In many embodiments, the compass tool is adapted to provide, in the CAD GUI, the displayed compass (or compass element) and its degree (rotation angle) indications and measurements in consistent locations and orientations. This facilitates a user's selection of a desired rotation including determining the current amount of angular rotation of the bend or other connector. To this end, the compass element may be provided in the GUI so as to be independent with the compass text orientation based off of the compasses own orientation within the model shown in the CAD GUI (e.g., not based off of the orientation of one entity to that of another entity in the model).

In many applications, 90 degrees is always up (highest Z point value) while 270 degrees is always down (lowest Z point value). One exception may be when the compass is perpendicular to the Z-axis (aligned to X-Y plane with all Z values the same). Also, 0 degrees is, in these examples, always on the side of the compass that has the higher point value in comparison to 180 degrees (0>180 degrees). For example, when connection direction is along the X-axis, 0 degrees follows the highest Y point value, and, when connection direction is along the Y-axis, 0 degrees follows the highest X point value (note, this is not based on absolute values such that negative one is >greater than negative two). The exception cases to these rules are when the compass is perpendicular in the GUI to the Z axis (i.e., aligned to X-Y plane (with all Z values the same)). In such a case, 90 degrees should be the highest X point value, 270 degrees should be the lowest X point value, 0 degrees should be the highest Y point value, and 180 degrees should be the lowest Y point value.

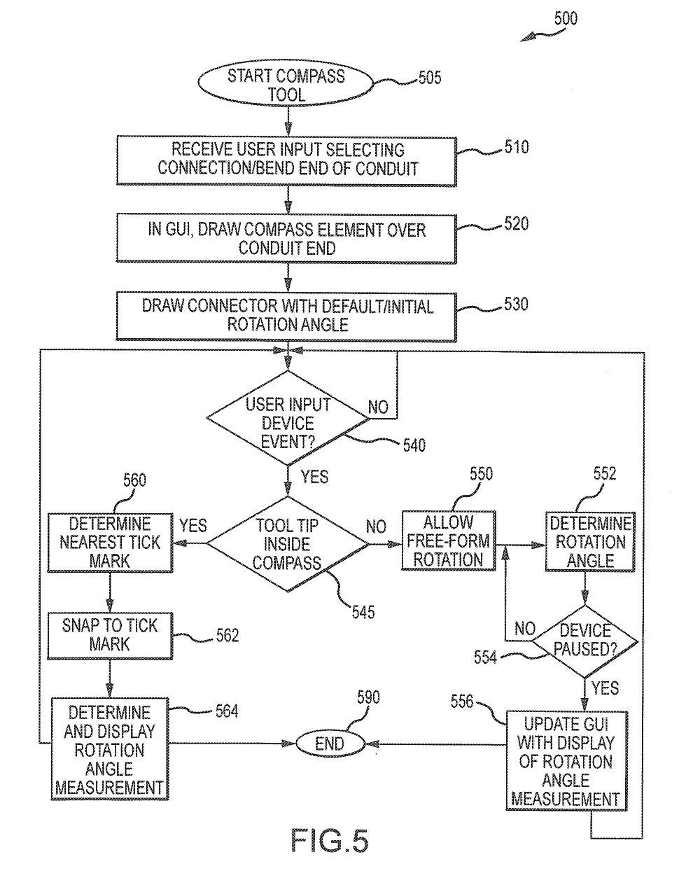

FIG. 5 is a flow diagram of a method 500 of generating and displaying a compass element or object (or “compass”) in a CAD GUI by operation of compass tool (such as the tool 138 of FIG. 1). The method 500 starts at 505 such as with loading a CAD program onto a computer or other computing device with the CAD program including a compass tool (such as part of a bend/connector modeling routine), and step 505 may include a user or CAD designer/modeler operating the computer to run the CAD program to generate a GUI viewable on their monitor/display device. Step 505 may also include the user further acting to initiate or open up (from a drop down menu or the like) the compass tool.

The method 500 continues with the compass tool monitoring user input devices for user input, and, at 510, the method 500 includes the compass tool (via a user input device such as a mouse or the like making a selection of displayed options in a bend/connector subroutine) receiving user input selecting a conduit and its end as a location for installing a connector (such as a conduit bend, elbow, or the like) and, in some cases, input initiating the compass tool. In step 520, the method 500 then continues with the compass tool generating and drawing/displaying in the CAD GUI the compass element over the user-selected conduit end/location. As shown in FIGS. 2-4, this may involve providing a graphical representation of a compass body or dial with one, two, three, four, or more bands defined by concentric circular-shaped boundaries/rings each with tick marks or the like providing visual indications of rotation angles for a bend/connector. The compass typically is provided as a planar body that is placed over and parallel to the end (location) of the conduit, and the compass has an outer diameter greater than the conduit to facilitate viewing the bands and/or tick marks.

The method 500 continues at 530 with drawing the connector/bend with one of its ends coupled to the end of the conduit selected by the user in step 510. The compass, hence, appears to be sandwiched (or disposed) between the two mating ends of the conduit segment and connector/bend. After step 530 is complete, the bend/connector typically is at a first or default rotation angle (or angular orientation) such as at 0 degrees rotation (or 90 degrees rotation or other useful default orientation). This default angular rotation may be displayed visually in the GUI in step 530 such as with a rotation angle indicator (e.g., an elongated bar) and/or a measurement display (e.g., a box) used to output the presently “measured” or determined rotation angle.

The method 500 continues at 540 with the monitoring for a user input device (e.g., a mouse event) in the GUI that affects the displayed compass and/or rotates the connector/bend provided in step 530. If not detected, the method 500 continues at 540 with additional monitoring. If a mouse event or other user input device event is detected at 540, the method 500 continues at 545 with a determination if the tool tip (associated with or manipulated with the user input device) is within the compass' body (or within the outermost circular boundary) or outside the compass in the GUI (e.g., pointing at a modeled structural element where it is desired to direct the conduit via the installed connector/bend).

When outside the compass, the compass tool may operate at 550 to allow the user to have free-form rotation of the connector/bend. Then, at 552, the compass tool 552 acts to determine the current rotation angle of the connector/bend due to the free-form rotation of the bend/connector. At 554, the compass tool monitors the use of the input device to identify if the tool tip has been paused at a location in the GUI outside the compass (e.g., paused for 0.25 to 1 seconds or other predefined minimum pause time period). If no pause (still rotating the bend/connector), the method 500 may continue at 552. If the tool tip is determined at 554 to be paused, the method 500 continues at 556 with the compass tool updating the GUI. This may involve the determined rotation angle for the connector/bend being displayed in the GUI such as in a display box or the like adjacent or proximate in the GUI to the tool tip. Throughout rotation, a rotation indicator (e.g., an elongated bar extending out from the center of the compass) may be moved in real time with movement of the tool tip. The method 500 may continue at 540 after step 556 or the method 500 may be ended at 590 (or the method 500 may be ended any time).

If at step 545, the compass tool determines that the tool tip is inside the body of the compass, the method 500 may continue at 560 with the compass tool determining a nearest tick mark in the band of the compass element in which the tool tip is positioned. Then, at 562, the compass tool may cause the tool tip to snap or jump to this tick mark. At step 564, the compass tool acts to determine the rotation angle and update the GUI to display the rotation angle measurement such as in a display box proximate to the tool tip. If provided, a rotation angle indicator is moved in a snapped manner to be over or parallel to the tick mark identified in step 560. The method 500 may then end at 590 or continue with monitoring for a next user input device event at step 540.

While this disclosure contains many specifics, these should not be construed as limitations on the scope of the disclosure or of what may be claimed, but rather as descriptions of features specific to particular embodiments of the disclosure. Furthermore, certain features that are described in this specification in the context of separate embodiments can also be implemented in combination in a single embodiment. Conversely, various features that are described in the context of a single embodiment can also be implemented in multiple embodiments separately or in any suitable subcombination. Moreover, although features may be described above as acting in certain combinations and even initially claimed as such, one or more features from a claimed combination can in some cases be excised from the combination, and the claimed combination may be directed to a subcombination or variation of a subcombination.

Similarly, while operations are depicted in the drawings in a particular order, this should not be understood as requiring that such operations be performed in the particular order shown or in sequential order, or that all illustrated operations be performed, to achieve desirable results. In certain circumstances, multitasking and/or parallel processing may be advantageous. Moreover, the separation of various system components in the embodiments described above should not be understood as requiring such separation in all embodiments, and it should be understood that the described program components and systems can generally be integrated together in a single software and/or hardware product or packaged into multiple software and/or hardware products.

The above described embodiments including the preferred embodiment and the best mode of the invention known to the inventor at the time of filing are given by illustrative examples only.

It should be stressed that in addition to the particular “conduit” examples provided in the figures the compass tool can be applied to any circular or square object (and such objects may also be thought of as conduit in the following claims). For example, the objects may include a tube as well as a solid face, which includes any tube used by the trades and also applies to solids (which may be attaching other objects) such as structural steel or the like. While not shown in the exemplary figures, the compass tool is also useful with square objects, and, in such use cases, the gradients on the compass may be limited differently than for circular objects such as to 90-degree rotations. The compass can be changed in appearance by the software based on the object being rotated or aligned, e.g., gradients of 90, 45, 15, and 5 degrees (or the like) for circular objects, a 90-degree gradient only for square objects, and so on.

We claim:

1. A user interface method, comprising:
with a processor of a computer system, running a computer-aided design (CAD) program to generate a graphical user interface (GUI) on a display device of the computer system;
with the CAD program, detecting, via operation of a user input device, user selection of a conduit end, displayed in the GUI, to connect with a connector to a next conduit run;
displaying the connector attached to the conduit end and rotated to an initial rotation angle relative to the central axis of the conduit end; and
displaying a compass element, with a circular-shaped planar body oriented to be orthogonal to the conduit end, over the conduit end, wherein the body of the compass element has an outer diameter greater than an outer diameter of the conduit end and a first band, including a plurality of compass measurement marks, extending outward from the conduit end.

2. The method of claim 1, further including concurrent with the displaying of the compass element, determining a current rotation angle of the connector and displaying a visual indication of the current rotation angle in the GUI.

3. The method of claim 2, wherein the visual indication comprises an elongated rotation angle indicator extending from a center of the body of the compass element to a point outside the body of the compass element.

4. The method of claim 2, wherein the visual indication comprises a display box including a numeric representation of the current rotation angle.

5. The method of claim 4, further including displaying a tool tip in the GUI corresponding to movement of the user input device causing rotation of the connector relative to the central axis of the conduit end, wherein the display box is displayed in a position adjacent and proximate to the tool tip in the GUI.

6. The method of claim 5, wherein the tool tip is snapped onto a nearest one of the compass measurement marks when the tool tip is positioned within the body of the compass element.

7. The method of claim 5, wherein the tool tip is positionable in the GUI to provide free-form rotation of the connector when the tool tip is positioned outside the body of the compass element and wherein the display box is displayed to provide the current rotation angle of the connector with the tool tip positioned in a 2D or 3D model of a structure displayed in the GUI.

8. The method of claim 1, wherein the body of the compass element comprises a second band including a plurality of compass measurement marks, wherein the first and second band are defined by concentric rings of differing diameter, and wherein the compass measurement marks of the first band, which is more inner than the second band, are spaced apart a greater distance than those of the second band indicative of a larger incremental measurement of a rotation angle of the connector.

9. The method of claim 8, wherein the compass measurement marks of the first band are provided at 90 degree increments and the compass measurement marks of the second band are provided at 45 degree increments.

10. The method of claim 9, further comprising third and fourth bands in the body of the compass element defined by additional concentric rings having greater diameters than the diameters of the concentric rings defining the first and second bands, wherein the compass measurement marks of the third band are provided at 15 degree increments and the compass measurement marks of the fourth band are provided at 5 degree increments.

11. The method of claim 1, wherein the connector is determined to be at a 90 degree rotation angle when rotated to extend vertically upward in the GUI.

12. A method of providing graphical representation connection of two conduit runs, comprising:
with a processor of a computer system, displaying a graphical user interface (GUI), including a three-dimensional model of a structure, on a display device of the computer system;
detecting user selection of a first conduit run, displayed in the GUI, to connect with a connector to a second conduit run;
displaying the connector attached to an end of the first conduit run;
displaying a compass element sandwiched between the connector and the end of the first conduit run, wherein the compass element comprises at least two concentric bands extending outward from and about the periphery of the first conduit run, wherein each of the concentric bands includes tick marks representing at least two differing angular rotation values of the connector relative to a center axis of the first conduit run, and wherein the displaying of the compass element includes determining and displaying a visual indication of a current rotation angle of the connector.

13. The method of claim 12, wherein the visual indication comprises an elongated rotation angle indicator extending from a center of the compass element to a point outside the compass element.

14. The method of claim 12, wherein the visual indication comprises a display box including a numeric representation of the current rotation angle.

15. The method of claim 14, further including displaying a tool tip in the GUI corresponding to movement of the user input device causing rotation of the connector relative to the central axis of the conduit end, wherein the display box is displayed in a position adjacent and proximate to the tool tip in the GUI.

16. The method of claim 15, wherein the tool tip is snapped onto a nearest one of the compass tick marks when the tool tip is positioned within the body of the compass element.

17. The method of claim 15, wherein the tool tip is positionable in the GUI to provide free-form rotation of the connector when the tool tip is positioned outside the compass element and wherein the display box is displayed to provide the current rotation angle of the connector with the tool tip positioned in the model of the structure displayed in the GUI.

18. The method of claim 12, wherein the tick marks of an innermost one of the bands are provided at 90 degree increments, the tick marks of a second innermost one of the bands are provided at 45 degree increments, the tick marks of a third innermost one of the bands are provided at 15 degree increments, and the tick marks of a fourth innermost one of the bands are provided at 5 degree increments.

19. A computer system, comprising:
a user input device;
a display device;
a processor executing code to provide a computer-aided design (CAD) program, wherein the CAD program:
generates and displays a graphical user interface (GUI), including a three-dimensional model of a structure, on the display device;
detects user selection of a first conduit run displayed in the GUI, via operation of the user input device, to connect with a connector to a second conduit run; and
displays the connector attached to an end of the first conduit run; and
a compass tool run by the processor displaying a compass element sandwiched between the connector and the end of the first conduit run, wherein the compass element comprises at least two concentric bands extending outward from and about the periphery of the first conduit run, wherein each of the concentric bands includes tick marks representing at least two differing angular rotation values of the connector relative to a center axis of the first conduit run, and wherein the displaying of the compass element includes determining and displaying a visual indication of a current rotation angle of the connector.

20. The computer system of claim 19, wherein the visual indication comprises an elongated rotation angle indicator extending from a center of the compass element to a point outside the compass element.

20. The computer system of claim 19, wherein the visual indication comprises a display box including a numeric representation of the current rotation angle.

21. The system of claim 20, wherein the compass tool displays a tool tip in the GUI corresponding to movement of the user input device causing rotation of the connector relative to the central axis of the conduit end and further wherein the display box is displayed in a position adjacent and proximate to the tool tip in the GUI.

22. The system of claim 21, wherein the tool tip is snapped onto a nearest one of the compass tick marks when the tool tip is positioned within the body of the compass element.

23. The system of claim 21, wherein the tool tip is positionable in the GUI to provide free-form rotation of the connector when the tool tip is positioned outside the compass element and wherein the display box is displayed to provide the current rotation angle of the connector with the tool tip positioned in the model of the structure displayed in the GUI.

24. The method of claim 19, wherein the tick marks of an innermost one of the bands are provided at 90 degree increments, the tick marks of a second innermost one of the bands are provided at 45 degree increments, the tick marks of a third innermost one of the bands are provided at 15 degree increments, and the tick marks of a fourth innermost one of the bands are provided at 5 degree increments.
